(19) United States
(12) Patent Application Publication
(10) Pub. No.: US 2021/0360271 A1
(43) Pub. Date: Nov. 18, 2021

(54) INTER PREDICTION IN EXPONENTIAL PARTITIONING

(71) Applicant: OP Solutions, LLC, Amherst, MA (US)

(72) Inventors: Borivoje Furht, BOCA RATON, FL (US); Hari Kalva, BOCA RATON, FL (US); Velibor Adzic, Canton, GA (US)

(73) Assignee: OP Solutions, LLC, Amherst, MA (US)

(21) Appl. No.: 17/386,840

(22) Filed: Jul. 28, 2021

Related U.S. Application Data
(63) Continuation of application No. PCT/US20/15408, filed on Jan. 28, 2020.
(60) Provisional application No. 62/797,816, filed on Jan. 28, 2019.

(51) Int. Cl. H04N 19/44; H04N 19/119; H04N 19/96; H04N 19/117; H04N 19/82; H04N 19/159; H04N 19/169; H04N 19/176

(52) U.S. Cl. CPC H04N 19/44; H04N 19/119; H04N 19/96; H04N 19/176; H04N 19/82; H04N 19/159; H04N 19/1883; H04N 19/117

(57) ABSTRACT

A decoder includes circuitry configured to receive a bitstream; partition a current block via an exponential partitioning mode into a first region and a second region; determine a motion vector associated with the first region or the second region, the determining including constructing a candidate list; and decode the current block using the determined motion vector. Related apparatus, systems, techniques and articles are also described.

### CROSS-REFERENCE TO RELATED APPLICATIONS

This application claims the benefit of priority of International Application No. PCT/US20/15408, filed on Jan. 28, 2020 and entitled “INTER PREDICTION IN EXPONENTIAL PARTITIONING,” which claims the benefit of priority of U.S. Provisional Patent Application Ser. No. 62/797,816, filed on Jan. 28, 2019, and titled “INTER PREDICTION IN EXPONENTIAL PARTITIONING.” Each of International Application No. PCT/US20/15408 and U.S. Provisional Patent Application Ser. No. 62/797,816 is incorporated by reference herein in its entirety.

### FIELD OF THE INVENTION

The present invention generally relates to the field of video compression. In particular, the present invention is directed to a inter prediction in exponential partitioning.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

### SUMMARY OF THE DISCLOSURE

In an aspect, a decoder, includes circuitry configured to receive a bitstream, partition a current block via an exponential partitioning mode into a first region and a second region, determine a motion vector associated with a region of the first region or the second region, wherein determining includes constructing a candidate list, and decode the current block using the determined motion vector.

In another aspect, a method includes receiving, by a decoder, a bitstream, partitioning, by the decoder, a current block via an exponential partitioning mode into a first region and a second region, determining, by the decoder, a motion vector associated with a region of the first region or the second region, the determining including constructing a candidate list, and decoding, by the decoder, the current block using the determined motion vector.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagram illustrating an example of block partitioning of pixels;

FIG. 2 is a diagram illustrating an example of geometric partitioning;

FIG. 3 illustrates an image containing an apple that may not be efficiently partitioned by straight line segments;

FIG. 4A is a diagram illustrating an example of exponential partitioning according to some aspects of the current subject matter, which can increase compression efficiency;

FIG. 4B is a series of diagrams illustrating example template exponential partitions;

FIG. 4C illustrates example curves associated with 4 predefined coefficients, which can define an example exponential function;

FIG. 4D illustrates another example block showing different starting P₁ and ending P₂ indices that partition the rectangular block;

FIG. 5 is a diagram illustrating example positions of potential motion vector candidates with respect to an example current block partitioned according to exponential partitioning;

FIG. 6 illustrates FIG. 5 with annotation showing luma locations including the upper-left most luma location of the first region and the upper right-most luma location of the second region;

FIG. 7 is a diagram illustrating positions of potential motion vector candidates with respect to an example current block partitioned according to exponential partitioning;

FIG. 8 illustrates FIG. 7 with annotation showing luma locations including the lower-left most luma location of the second region and the upper-right most luma location of the second region;

FIG. 9 is a system block diagram illustrating an example video encoder capable of encoding a video using inter prediction with exponential partitioning;

FIG. 10 illustrates an example of QTBT partitioning of a frame;

FIG. 11 illustrates an example of exponential partitioning at the CU level of the QTBT illustrated in FIG. 8;

FIG. 12 is a process flow diagram illustrating an example process of encoding a video with exponential partitioning an inter prediction according to some aspects of the current subject matter that can reduce encoding complexity while increasing compression efficiency;

FIG. 13 is a system block diagram illustrating an example decoder capable of decoding a bitstream using exponential partitioning and inter prediction according to some aspects of the current subject matter;

FIG. 14 is a process flow diagram illustrating an example process of decoding a bitstream using exponential partitioning and using inter prediction according to some aspects of the current subject matter; and

FIG. 15 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Some implementations of the current subject matter include performing inter prediction with non-rectangular regions that have been partitioned with a curve; the curve may or may not be a straight line. Performing inter prediction with non-rectangular blocks that have been partitioned with a curve can allow partitioning to more closely follow object boundaries, resulting in lower motion compensation prediction error, smaller residuals, and thus improved compression efficiency. During inter prediction, motion compensation can be performed using motion vectors predicted for blocks (e.g., coding units, prediction units, and the like) determined according to an exponential partitioning mode. Motion vectors can be predicted using advanced motion vector prediction (AMVP) and/or via merge mode, where the motion vector is selected from a list of motion vector candidates without encoding a motion vector difference.

In exponential partitioning, a rectangular block may be partitioned into non-rectangular regions with a curve, which may include a straight line segment in the case of geometric partitioning, or may in a more general case be a curve that is not a straight line. Using a curve that is not a straight line to partition blocks may allow partitioning to more closely follow object boundaries, resulting in lower motion compensation prediction error, smaller residuals, and thus improved compression efficiency. In some implementations, the curve may be characterized by an exponential function. The curve (e.g., exponential function) may be determined using predefined coefficients, which may be signaled in a bitstream for use by a decoder. In some implementations, exponential partitioning may be available for greater than or equal to 8×8 luma samples. By partitioning rectangular blocks with a curve, the current subject matter may achieve greater compression efficiency for certain objects than techniques limited to straight line segment partitions, such as with geometric partitioning.

Motion compensation may include an approach to predict a video frame or a portion thereof given the previous and/or future frames by accounting for motion of the camera and/or objects in the video. Motion compensation may be employed in encoding and decoding video data for video compression, for example in the encoding and decoding using the Motion Picture Experts Group (MPEG)-2 (also referred to as advanced video coding (AVC)) standard. Motion compensation may describe a picture in terms of transformation of a reference picture to a current picture. Reference picture may be previous in time or from the future when compared to current picture. When images can be accurately synthesized from previously transmitted and/or stored images, compression efficiency can be improved.

Block partitioning may refer to a method in video coding to find regions of similar motion. Some form of block partitioning may be found in video codec standards including MPEG-2, H.264 (also referred to as AVC or MPEG-4 Part 10), and H.265 (also referred to as High Efficiency Video Coding (HEVC)). In example block partitioning approaches, non-overlapping blocks of a video frame may be partitioned into rectangular sub-blocks to find block partitions that contain pixels with similar motion. This approach can work well when all pixels of a block partition have similar motion. Motion of pixels in a block may be determined relative to previously coded frames.

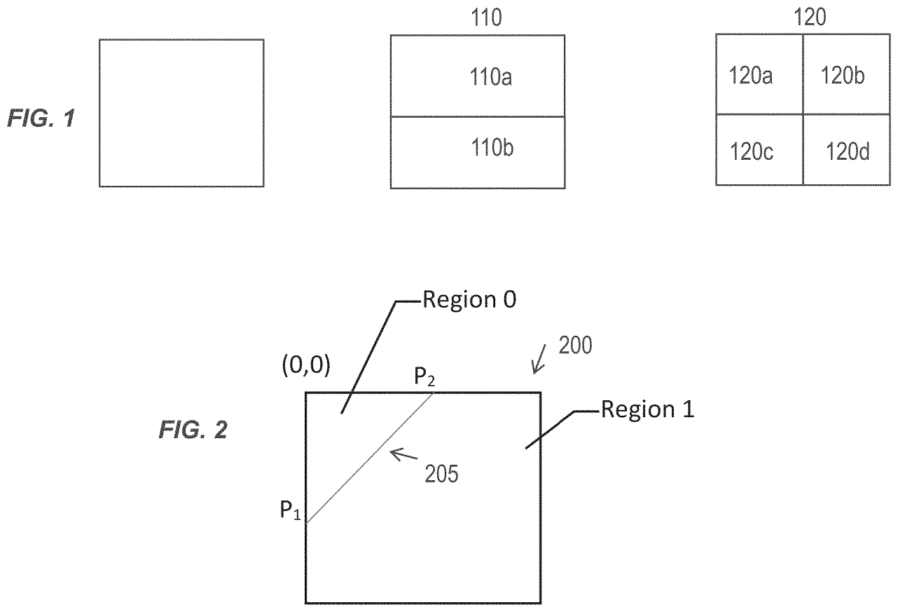

FIG. 1 is a diagram illustrating an example of block partitioning of pixels. An initial rectangular picture or block 100, which may itself be a sub-block (e.g., a node within a coding tree), can be partitioned into rectangular sub-blocks. For example, at 110, block 100 is partitioned into two rectangular sub-blocks 110a and 110b. Sub-blocks 110a and 110b can then be processed separately. As another example, at 120, block 100 is partitioned into four rectangular sub-blocks 120a, 120b, 120c, and 120d. Sub-blocks may themselves be further divided until it is determined that the pixels within the sub-blocks share the same motion, a minimum block size is reached, or another criteria. When pixels in a sub-block have similar motion, a motion vector can describe the motion of all pixels in that region.

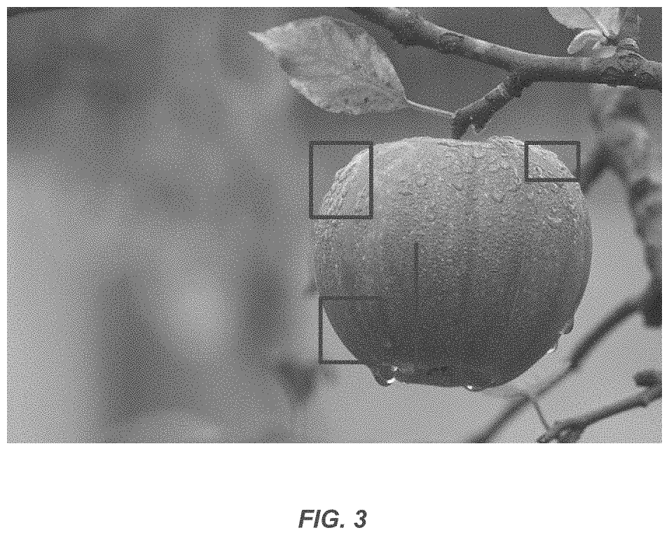

Still referring to FIG. 1, some approaches to video coding can include geometric partitioning, which may be a form of exponential partitioning in which a rectangular block (e.g., as illustrated in FIG. 1) is further divided by a straight line segment into two regions that may be non-rectangular. For example, FIG. 2 is a diagram illustrating an example of geometric partitioning. An example rectangular block 200 (which can have a width of M pixels and a height of N pixels, denoted as M×N pixels) may be divided along a straight line segment P₁P₂ 205 into two regions (region 0 and region 1). When pixels in region 0 have similar motion, a motion vector may describe the motion of all pixels in that region. The motion vector may be used to compress region 0. Similarly, when pixels in region 1 have similar motion, an associated motion vector may describe the motion of pixels in region 1. Such a geometric partition may be signaled to the receiver (e.g., decoder) by encoding positions P₁ and P₂ (or representations of positions P₁ and P₂) in the video bitstream.

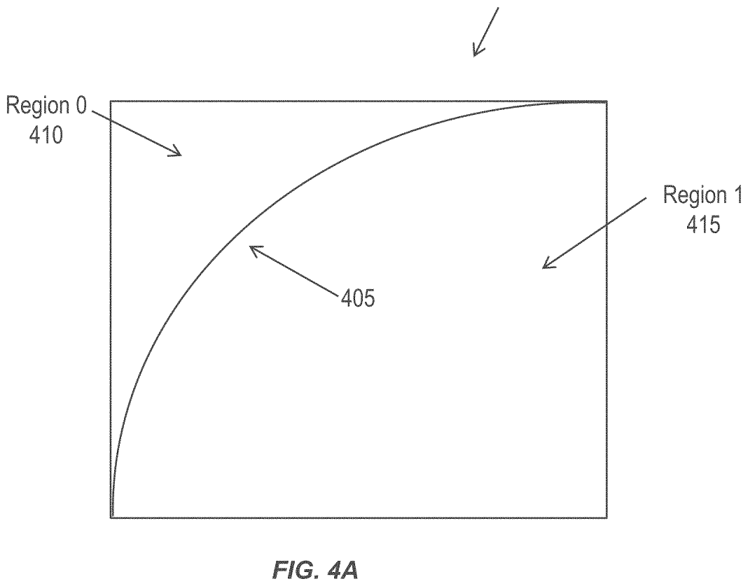

With continued reference to FIG. 2, when encoding video data utilizing geometric partitioning, straight line segment 205 (or more specifically points P₁ and P₂) may be determined. However, a straight line segment may not be capable of partitioning the block in a manner that reflects object boundaries. As a result, partitioning with straight line segments may not be capable of partitioning a block in an efficient manner (e.g., such that any resulting residual is small). This can be true where the block may contain pixels (e.g., luma samples) representing an object or boundary having a curved (e.g., non-straight) boundary. For example, FIG. 3 illustrates an exemplary embodiment of an image containing an apple that may not be efficiently partitioned by straight line segments; the image of the apple as illustrated include several rectangular blocks indicating portions of the image which, if partitioned using a straight line segment according to geometric partitioning, the partitioning may not closely follow the object (e.g., apple) boundary, which as illustrated in FIG. 3 is curved.

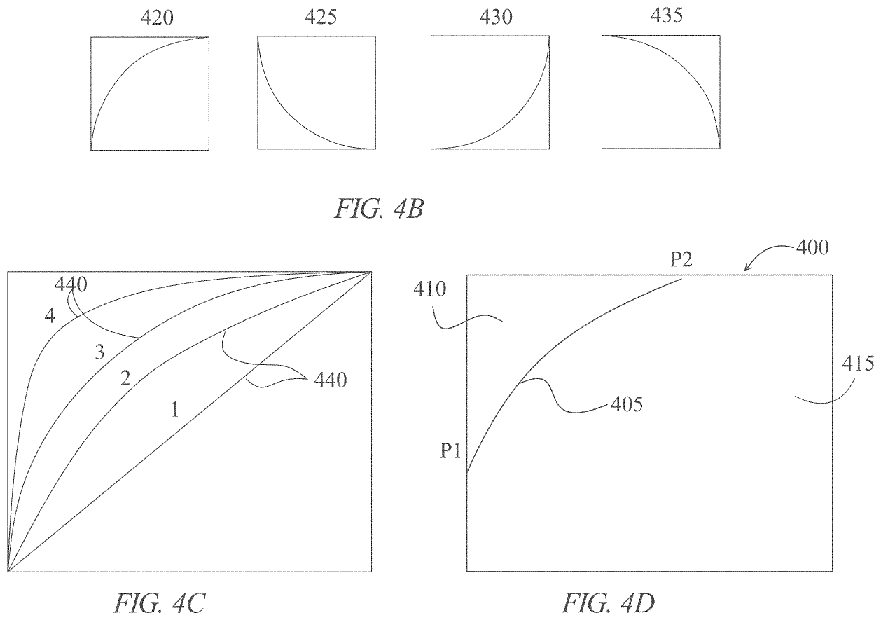

FIG. 4A is a diagram illustrating a non-limiting example of exponential partitioning using a non-linear curve, defined for the purposes of this disclosure as a curve that is not a straight line, according to some aspects of the current subject matter, which may increase compression efficiency. A rectangular block 400 may include pixels (e.g., luma samples). Rectangular block 400 may have, as a non-limiting example provided for illustrative purposes only, a size of 8×8 pixels (e.g., luma samples), or greater.

In FIG. 4A, rectangular block 400 may be partitioned into two or more regions, illustrated for exemplary purposes in FIG. 4A as region 0 and region 1, denoted by 410 and 415, respectively, by curved line 405. All luma samples in each region so defined may be considered or similar motion, and thus to be representable using the same motion vector. To illustrate for exemplary purposes, all luma samples within region 410 may be considered to have the same or similar motion and may be represented by the same motion vector. Similarly, all luma samples within region 415 may be considered to have the same or similar motion and may be represented by the same motion vector. As described more fully below, respective motion vectors may be determined according to an AMVP mode or a merge mode. In some implementations, and for the purposes of discussion, all luma samples to the left or above a curved line segment 405 dividing a rectangular block 400 may be considered to belong to region 0 (410). In some implementations, all luma samples to the right or below a curved line segment 405 dividing a rectangular block 400 may be considered to belong to region 1 (415). In some implementations, all luma samples through which a curved line segment dividing a rectangular block 400 passes (i.e. luma samples on and/or intersected by the line segment) belong to region 0 (410). In some implementations, all luma samples through which a curved line segment dividing a rectangular block 400 passes may be considered to belong to region 1 (415). Other implementations can be possible, as will occur to persons skilled in the art upon reviewing the entirety of this disclosure.

Still referring to FIG. 4A, exponential partitioning may be represented in a bitstream. In some implementations, an exponential partitioning mode may be utilized, and appropriate parameters may be signaled in a bitstream. For example, exponential partitioning may be represented in a bitstream by signaling predetermined exponential partitioning templates. FIG. 4B is a series of diagrams illustrating non-limiting examples of template partitions 420-435. In some implementations, signaling may be performed by including an index to one or more of these regular (e.g., template) exponential partitions that are predefined. These regular exponential partitions may specify a set of predetermined orientations. For example, FIG. 4C illustrates non-limiting exemplary curves associated with 4 predefined templates (1, 2, 3, 4). The number of template curvatures can vary in some implementations.

Continuing to refer to FIG. 4B, and as another non-limiting example, exponential partitions may be represented in a bitstream by signaling predetermined coefficients, such as coefficients of exponential functions, that indicate the degree of curvature, which may allow for additional exponential functions.

In some implementations, and still referring to FIG. 4B, a predefined template, of plurality of templates 420-435, used in an exponential partitioning mode may indicate a straight line segment. For example, in FIG. 4C, the segment indexed by coefficient 1 is a straight line, which can be considered a special case of exponential partitioning that is a geometric partitioning, as described above.

In some implementations, both orientation templates, as illustrated for example in FIG. 4B, and predefined templates, as illustrated for example in FIG. 4C, may be utilized to efficiently signal any exponential pattern of a large number of potential exponential partitions; for instance, templates may provide curve options 440, including without limitation a line segment 1 and/or one or more non-linear curves 2-4, which may include exponential curves, any of which may be selected by an encoder, a user, and/or an automated process to create a partition as described in this disclosure.

In some implementations, and referring again to FIG. 4A, starting and ending indices may be predetermined. For example, FIG. 4A illustrates an exemplary curved line segment starting at a lower left-hand corner of a rectangular block 400 and ending at an upper right hand corner of rectangular block 400. Such predetermined starting and ending indices may be stored in memory of a decoder. Alternatively or additionally, in some implementations, starting and ending indices may be explicitly signaled in the bitstream. For example, FIG. 4D illustrates another example block showing different starting P₁ and ending P₂ indices that partition the rectangular block 400. The starting P₁ and ending P₂ indices may be signaled directly or may be indicated by an index into a set of predetermined values. Other parameters are possible, as will occur to persons skilled in the art upon reviewing the entirety of this disclosure.

Still referring to FIG. 4A, inter prediction may be performed using regions that have been exponentially partitioned. Motion vectors for motion compensation may be derived using AMVP or merge mode. In AMVP, a motion vector prediction may be made by signaling an index into a motion vector candidate list and a motion vector difference (e.g., residual) may be encoded and included in the bitstream. In merge mode, a motion vector is selected from a list of motion vector candidates without encoding a motion vector difference thereby enabling a current block to adopt motion information of another previously decoded block. In both AMVP and merge mode, a candidate list may be constructed by both an encoder and decoder, and an index into the candidate list may signaled in a bitstream.

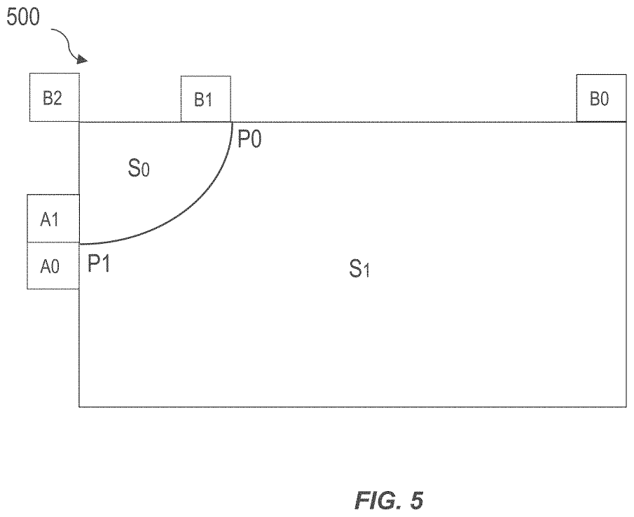

FIG. 5 is a diagram illustrating non-limiting examples of positions of potential spatial motion vector candidates with respect to an example current block 1100 partitioned according to exponential partitioning. Potential spatial motion vector candidates may be considered for constructing a motion vector candidate list during AMVP mode or merge mode. As a non-limiting example, a current block 1100 may be partitioned into two regions, region S0 and region S1, by a curve between points P0 and P1. Each of region S0 and region S1 may be uni- or bi-directionally predicted. Spatial candidates for a first region (region S0) are illustrated for exemplary purposes in FIG. 5 and may include, without limitation, a lower-left candidate A0, a left candidate A1, an upper-left candidate B2, an upper candidate B1 and an upper-right candidate B0.

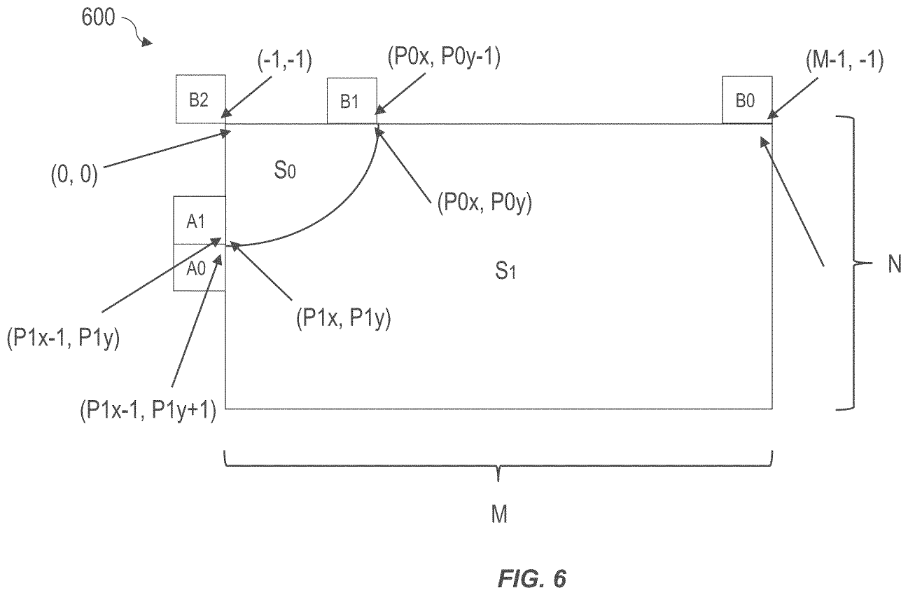

As illustrated in FIG. 5, and in some implementations, each location (A0, A1, B2, B1, and B0) may represents a block at the respective location. For example, and without limitation, an upper-left candidate B2 is may represent a block that resides at a location that is immediately to the left and immediately above region S0; for example, if an upper-left corner luma location of S0 is (0, 0), then the upper left candidate may B2 reside at location (−1,−1). A lower-left candidate A0 may be located immediately to the left and below of P1; for example, and without limitation, if P1's luma location is (P1x, P1y), the lower-left candidate A0 may reside at location (P1x−1, P1y+1). A left candidate A1 may be located immediately to the left of P1; for example, the left candidate A1 may reside at location (P1x−1, P1y). An upper candidate B1 may be located immediately above P0; or example, if P0's luma location is (P0x, P0y), the above candidate B1 is located at (P0x, P0y−1). An above-right candidate B0 may be located immediately above an upper and right-most luma location in a second region S1; or example, if the upper-right corner of S1 is located at (S0_width+S1_width−1, 0), then the above-right candidate B0 may be located at (S0_width+S1_width−1, −1), where M=S0_width+S1_width. Other locations are possible, as will occur to persons skilled in the art upon reviewing the entirety of this disclosure. FIG. 6 illustrates FIG. 5 with annotation showing luma locations including the upper-left most luma location of the first region S0 and the upper right-most luma location of the second region S1.

In some implementations, and still referring to FIG. 6, when constructing a candidate list for region S0, some of potential candidates may be automatically marked as unavailable and removed from the list because, where there is exponential partitioning, such partitioning may be performed to partition regions (or objects) within a frame that have different motion information. Accordingly, it may be inferred that blocks associated with those candidates likely represent another object with different motion and therefore these candidates may be automatically marked as unavailable (e.g., not further considered, removed from the list, and the like). As a non-limiting example, and, as illustrated above in FIG. 5, for region S0, a lower-left candidate A0 may be automatically marked as unavailable because it is likely that region S0 does not share motion information with a block located at the lower-left candidate A0. Similarly, for region S0, an upper-right candidate B0 may be automatically marked as unavailable because it is likely that region S0 does not share motion information with a block located at the upper-right candidate B0.

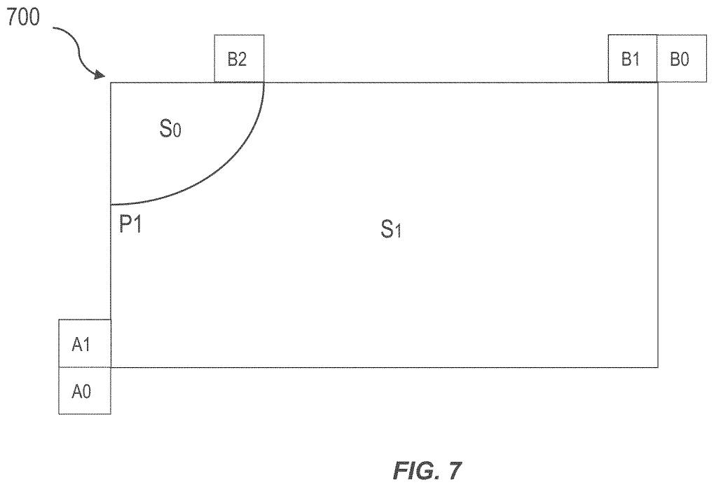

FIG. 7 is a diagram illustrating non-limiting examples of positions of potential motion vector candidates with respect to an example current block 1400 partitioned according to exponential partitioning. Potential motion vector candidates may be considered for constructing a candidate list during AMVP mode or merge mode. A current block 1400 may have been partitioned into two regions, region S0 and region S1, by a curve between points P0 and P1. Each of region S0 and region S1 may be uni- or bi-directionally predicted. Candidates for the second region (region S1) is illustrated in FIG. 7 and may include a lower-left candidate A0, a left candidate A1, an upper-left candidate B2, an upper candidate B1 and an upper-right candidate B0.

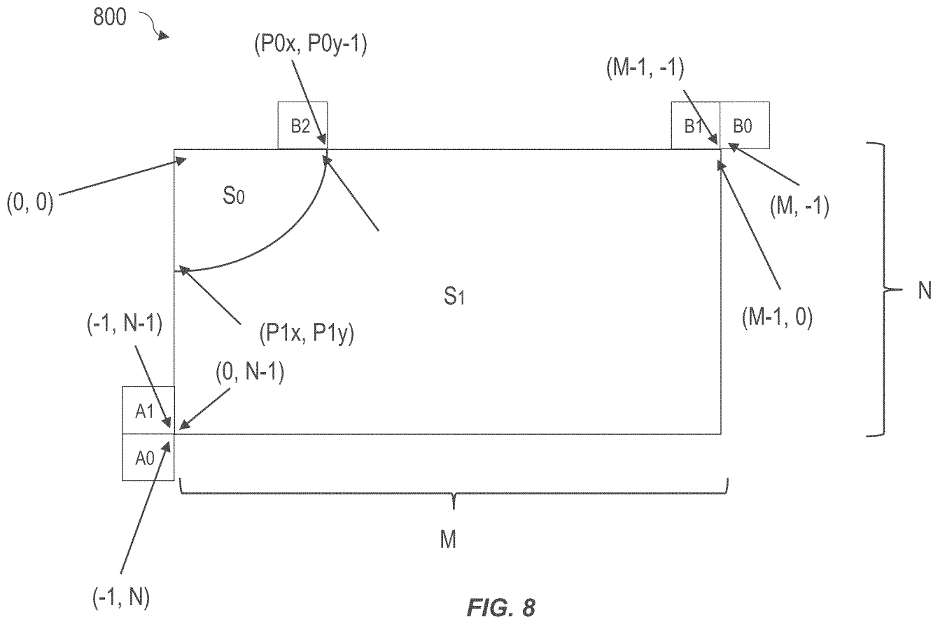

As illustrated, in FIG. 7, each location (A0, A1, B2, B1, and B0) may represent a block at the respective location. For example, an upper-left candidate B2 may be a block that resides at a luma location that is immediately to the left and immediately above region S1; for example, if the upper-left corner luma location of S1 is adjacent P0 with luma location coordinates (P0x+1, P0y), then the upper left candidate B2 may reside at location (P0x,P0y−1). a lower-left candidate A0 may be located immediately to the left and below a lower-left most luma location of S1; for example, if the lower-left most luma location of S1 is luma location (0, S0_height+S1_height−1), the lower-left candidate A0 may reside at location (−1, S0_height+S1_height), where N=S0_height+S1_height. A left candidate A1 may be located immediately to the left of a lower-left most luma location of S1 (e.g., lower-left corner of S1); for example, if the lower-left most luma location of S1 is luma location (0, S0_height+S1_height−1), the left candidate A1 may reside at luma location (−1, S0_height+1_height−1). An upper candidate B1 may be located immediately above an upper-right most luma location of S1; for example, if the upper-right most luma location of S1 is (S0_width+S1_width−1, 0), then the above candidate B1 may be located at (S0_width+S1_width−1, −1), where M=S0_width+S1_width. An above-right candidate B0 may be located immediately above and to the right of an upper-right most luma location of second region S1; for example, if an upper-right most luma location of S1 (e.g., upper right corner) is located at (S0_width+S1_width−1, 0), then the above-right candidate B0 may be located at (S0_width+S1_width, −1). FIG. 8 illustrates FIG. 7 with annotation showing luma locations including the lower-left most luma location of the second region S1 and the upper-right most luma location of the second region S1.

In some implementations, and still referring to FIG. 8, when constructing a candidate list for region S1, some potential candidates may be automatically marked as unavailable and removed from the list because, where there is exponential partitioning, such partitioning may be performed to partition regions (or objects) within a frame that have different motion information. Accordingly, it may be inferred that blocks associated with those candidates likely represent another object with different motion and therefore these candidates may be automatically marked as unavailable (e.g., not further considered, removed from the list, and the like). In the example of FIG. 7, for region S1, an upper-left candidate B2 may be automatically marked as unavailable because it is likely that region S1 does not share motion information with a block located at the above-left candidate B2.

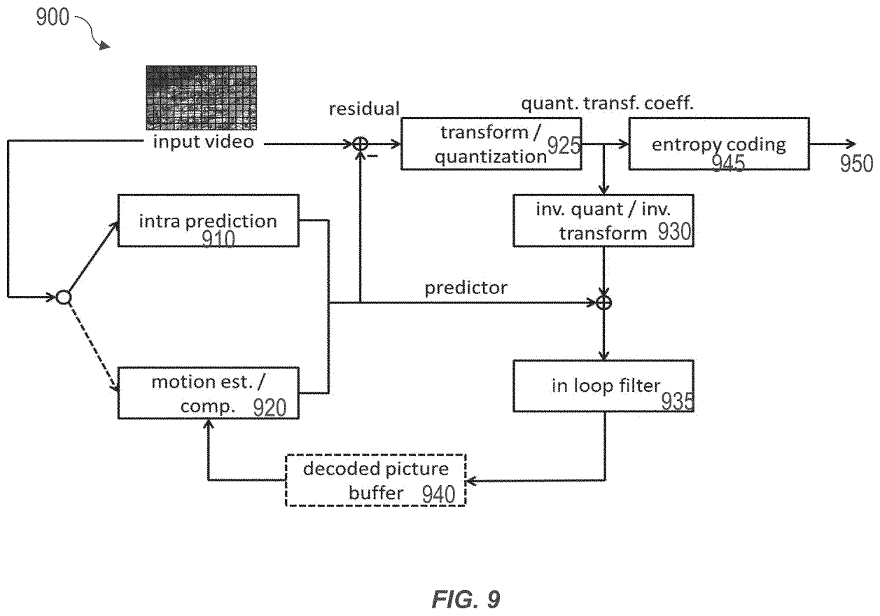

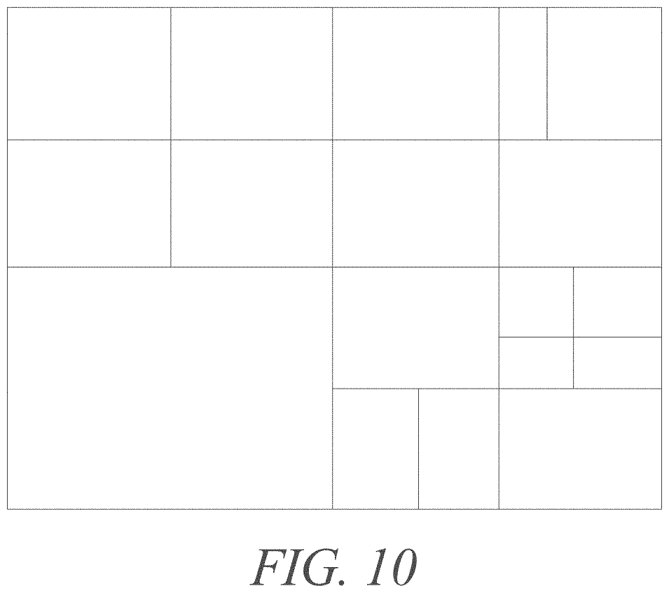

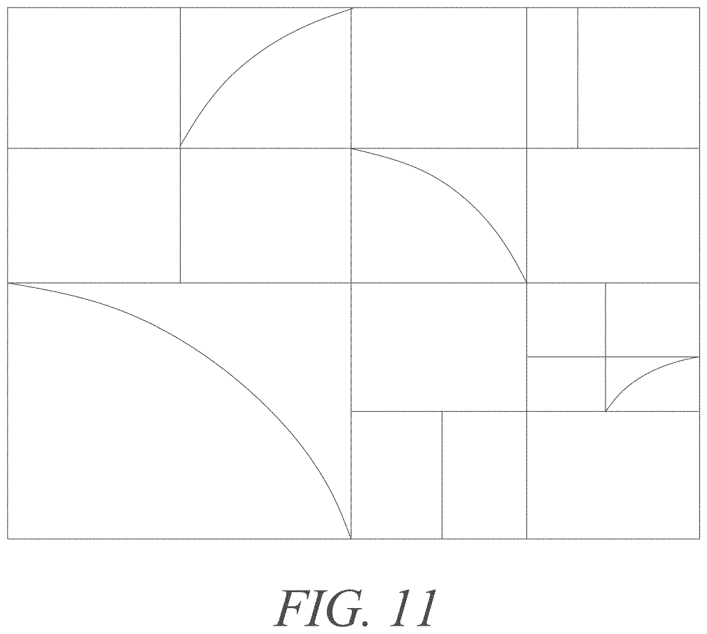

FIG. 9 is a system block diagram illustrating a non-limiting example of a video encoder 900 capable of encoding a video using inter prediction with exponential partitioning. The example video encoder 900 receives an input video 905, which may be initially segmented or divided according to a processing scheme, such as a tree-structured coding block partitioning scheme (e.g., quad-tree plus binary tree (QTBT)). An example of a tree-structured coding block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that can be called predictive units (PU). Transform units (TU) may also be utilized. Such a partitioning scheme may include performing exponential partitioning according to some aspects of the current subject matter. FIG. 8 illustrates an example of QTBT partitioning of a frame, and FIG. 11 illustrates an example of exponential partitioning at the CU level of the QTBT illustrated in FIG. 8.

Still referring to FIG. 9, an example video encoder 900 may include an intra prediction processor 915, a motion estimation/compensation processor 920 (also referred to as an inter prediction processor) capable of supporting exponential partitioning including AMVP and merge mode, a transform/quantization processor 925, an inverse quantization/inverse transform processor 930, an in-loop filter 935, a decoded picture buffer 940, and an entropy coding processor 945. In some implementations, motion estimation/compensation processor 920 may perform inter prediction using exponential partitioning and including use of AMVP mode and merge mode. Bitstream parameters that signal exponential partitioning modes, AMVP mode, and merge mode may be input to entropy coding processor 945 for inclusion in output bitstream 950.

In operation, and with continued reference to FIG. 9, for each block of a frame of the input video 905, whether to process the block via intra picture prediction or using motion estimation/compensation may be determined. Block may be provided to intra prediction processor 910 or motion estimation/compensation processor 920. If block is to be processed via intra prediction, intra prediction processor 910 may perform the processing to output the predictor. If block is to be processed via motion estimation/compensation, motion estimation/compensation processor 920 may perform the processing including use of exponential partitioning with AMVP mode and merge mode to output the predictor.

Still referring to FIG. 9, a residual may be formed by subtracting predictor from input video. Residual may be received by transform/quantization processor 925, which may perform transformation processing (e.g., discrete cosine transform (DCT)) to produce coefficients, which may be quantized. Quantized coefficients and any associated signaling information may be provided to entropy coding processor 945 for entropy encoding and inclusion in output bitstream 950. Entropy encoding processor 945 may support encoding of signaling information related to exponential partitioning modes, AMVP mode, and merge mode. In addition, quantized coefficients may be provided to inverse quantization/inverse transformation processor 930, which may reproduce pixels, which may be combined with predictor and processed by in loop filter 935, an output of which may be stored in decoded picture buffer 940 for use by motion estimation/compensation processor 920 that is capable of supporting exponential partitioning modes, AMVP mode, and merge mode.

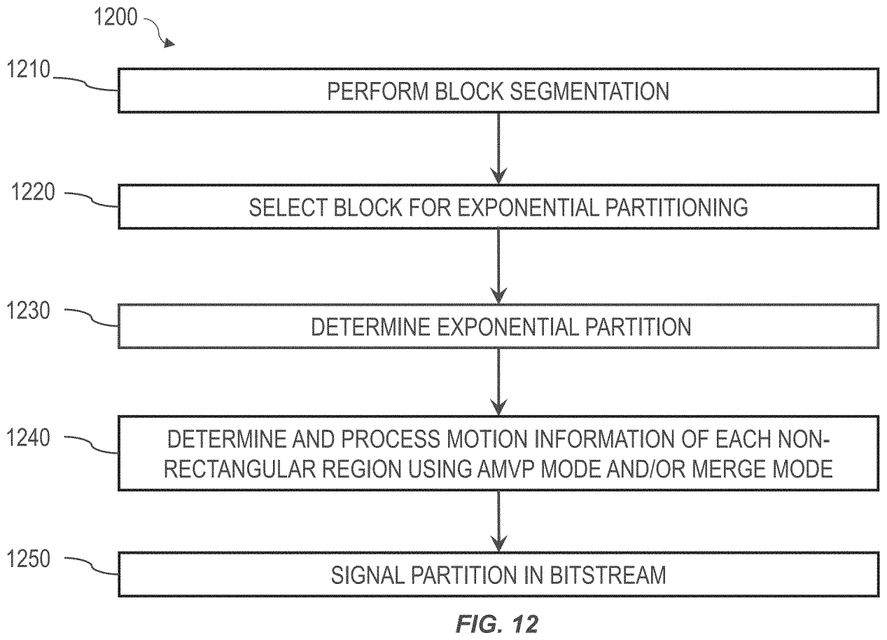

FIG. 12 is a process flow diagram illustrating an example process 1200 of encoding a video with exponential partitioning an inter prediction according to some aspects of the current subject matter that can reduce encoding complexity while increasing compression efficiency. At step 1210, a video frame may undergo initial block segmentation, for example, using a tree-structured coding block partitioning scheme that can include partitioning a picture frame into CTUs and CUs. At step 1220, a block may be selected for exponential partitioning; exponential partitioning may include geometric partitioning or may include exponential partitioning using a non-linear curve. Selection may include identifying according to a metric rule that block is to be processed according to an exponential partitioning mode.

At step 1230, and continuing to refer to FIG. 12, an exponential partition may be determined. A curved line and/or line segment (e.g., 405) and/or straight line and/or line segment may be determined that will separate pixels contained within block according to their inter frame motion into two non-rectangular regions (e.g., region 0 and region 1) such that pixels (e.g., luma samples) within one of the regions (e.g., region 0) have similar motion and pixels within the other region (e.g., region 1) have similar motion.

At step 1240, and with continued reference to FIG. 12, motion information of each non-rectangular region may be determined and processed using AMVP mode or merge mode. When processing a region using AMVP mode, a candidate list may be constructed by considering both spatial and temporal candidates, including spatial candidates as described above, and including marking some candidates as unavailable. A motion vector may be selected from a list of motion vector candidates as a motion vector prediction and a motion vector difference (e.g., residual) may be computed. An index into candidate list may be determined. In merge mode, a candidate list may be constructed by considering both spatial and temporal candidates, including the spatial candidates described above, and including marking some candidates as unavailable. A motion vector may be selected from a list of motion vector candidates for the region to adopt the motion information of another block. An index into the candidate list may be determined.

At step 1250, and with continued reference to FIG. 12, a determined exponential partition and motion information may be signaled in a bitstream. Signaling exponential partitions in a bitstream may include, for example, including an index into one or more predetermined templates and/or coefficients. Signaling of motion information when processing a region using AMVP may include including a motion vector difference (e.g., residual) and index into a motion vector candidate list in bitstream. Signaling of motion information when processing a region using merge mode may include including an index into a motion vector candidate list in bitstream.

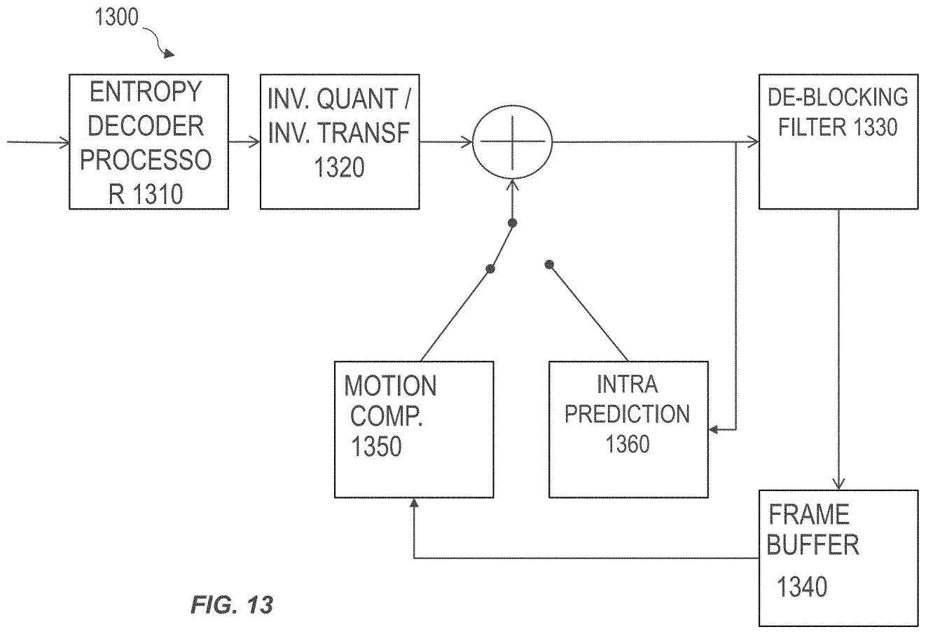

FIG. 13 is a system block diagram illustrating an example decoder 600 capable of decoding a bitstream 1370 using exponential partitioning and inter prediction according to some aspects of the current subject matter. Decoder 600 may include an entropy decoder processor 1310, an inverse quantization and inverse transformation processor 1320, a deblocking filter 1330, a frame buffer 1340, motion compensation processor 1350 and intra prediction processor 1360. In some implementations, bitstream 1370 includes parameters that signal an exponential partitioning mode, AMVP mode, and merge mode. Motion compensation processor 1350 may reconstruct pixel information using exponential partitioning and inter prediction as described in this disclosure.

In operation, bitstream 1370 may be received by decoder 600 and input to entropy decoder processor 1310, which entropy decodes the bitstream into quantized coefficients. Quantized coefficients may be provided to inverse quantization and inverse transformation processor 1320, which may perform inverse quantization and inverse transformation to create a residual signal, which may be added to an output of motion compensation processor 1350 or intra prediction processor 1360 according to a processing mode. Output of motion compensation processor 1350 and intra prediction processor 1360 may include a block prediction based on a previously decoded block. A sum of the prediction and residual may be processed by deblocking filter 1330 and stored in a frame buffer 1340. For a given block, (e.g., CU or PU), when bitstream 1370 signals that a partitioning mode is exponential partitioning, motion compensation processor 1350 may construct a prediction based on exponential partitioning approach described herein and using either AMVP or merge modes as described herein.

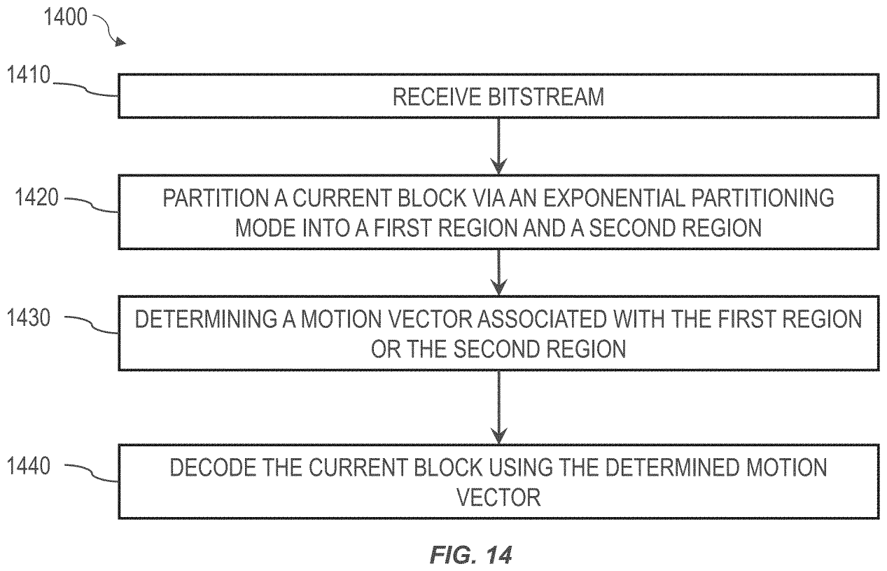

FIG. 14 is a process flow diagram illustrating an example process 1400 of decoding a bitstream using exponential partitioning and using inter prediction according to some aspects of the current subject matter. At step 1410, a bitstream is received. Receiving may include extracting and/or parsing bitstream and associated signaling information from the bitstream including parsing a current block and associated signaling information from the bitstream.

At step 1420, and still referring to FIG. 14, a current block may be partitioned via an exponential partitioning mode into a first region and a second region. Partitioning may include determining whether exponential partitioning mode is enabled (e.g., true) for block, indicating use of exponential partitioning using non-linear curves. If exponential partitioning mode is not enabled (e.g., false), decoder may process block using an alternative exponential partitioning mode such as geometric partitioning; parameters for geometric partitioning, including without limitation line segment endpoints, coefficients, or the like, may be received from bitstream as described above. If exponential partitioning mode is enabled (e.g., true), the decoder may extract or determine one or more parameters that characterize exponential partitioning. These parameters may include, for example, exponential coefficient indices, exponential coefficient values, orientation template indices, and/or the indices of the start and end of the curved line (e.g., P₁P₂). Extraction or determining may include identifying and retrieving the parameters from the bitstream (e.g., parsing the bitstream).

At step 1430, and with continued reference to FIG. 14, a motion vector associated with a region of first region or second region may be determined. Determining motion vector may include determining whether a motion information of region is to be determined using AMVP mode or merge mode. When processing a region using AMVP mode, a candidate list may be constructed by considering both spatial and temporal candidates, including spatial candidates described above, and including marking some candidates as unavailable. A motion vector may be selected from a list of motion vector candidates as a motion vector prediction and a motion vector difference (e.g., residual) may be computed. In merge mode, the determining can include constructing a candidate list of spatial candidates and temporal candidates for each region. For each region, spatial candidates may be spatial candidates as described above with respect to FIGS. 5-8. Constructing candidate list may include automatically marking candidates as unavailable and removing unavailable candidates from candidate list. An index into a constructed candidate list may be parsed from bitstream and used to select a final candidate from the candidate list. Motion information for a current region may be determined to be the same as motion information of a final candidate (e.g., the motion vector for the region can be adopted from the final candidate).

At step 1440, and still referring to FIG. 14, a current block may be decoded using the determined motion vector.

Still referring to FIG. 14, although a few variations have been described in detail above, other modifications or additions are possible. For example, in some implementations, exponential partitioning may apply to symmetric blocks (8×8, 16×16, 32×32, 64×64, 128×128, and the like) as well as various asymmetric blocks (8×4, 16×8, and the like).

With continued reference to FIG. 14. partitioning may be signaled in a bitstream based on rate-distortion decisions in an encoder. Coding may be based on a combination of regular pre-defined partitions (e.g., templates), temporal and spatial prediction of the partitioning, and additional offsets. Each exponential partitioned region may utilize motion compensated prediction or intra-prediction. A boundary of predicted regions may be smoothed before a residual is added. For residual coding, an encoder may select between a regular rectangular DCT for the whole block and a Shape Adaptive DCT for each region.

Still referring to FIG. 14, in some implementations, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit (CU) level, a joint-classifier decision tree structure may eliminate unnecessary iterations and control the risk of false prediction. In some implementations, exponential partitioning may be available as an additional partitioning option available at every leaf node of QTBT. In some implementations, exponential partitioning is available as an additional coding tool on a CU level of QTBT partitioning. For example, FIG. 8 illustrates an example of QTBT partitioning of a frame, and FIG. 11 illustrates an example of exponential partitioning at the CU level of the QTBT illustrated in FIG. 8.

In some implementations, a decoder includes an exponential partitioning processor that may generates exponential partitioning for a current block and provide all partition-related information for dependent processes. Exponential partitioning processor may directly influence motion compensation as it may be performed segment-wise in case a block is exponentially partitioned. Further, a partition processor may provide shape information to the intra-prediction processor and the transform coding processor.

In some implementations, additional syntax elements may be signaled at different hierarchy levels of the bitstream. For enabling exponential partitioning for an entire sequence, an enable flag may be coded in a Sequence Parameter Set (SPS). Further, a CTU flag may be coded at a coding tree unit (CTU) level to indicate whether any coding units (CU) use exponential partitioning. A CU flag may be coded to indicate whether a current coding unit utilizes exponential partitioning. Parameters which specify a curved line on a block may be coded. For each region, a flag may be decoded, which specifies whether a current region is inter- or intra-predicted.

In some implementations, a minimum region size may be specified.

The subject matter described herein provides many technical advantages. For example, some implementations of the current subject matter may provide for partitioning of blocks that increases compression efficiency. In some implementations, by implementing partitioning in a manner that more closely follows object boundaries, effective visual effects can be achieved. Similarly, in some implementations, by implementing partitioning in a manner that more closely follows object boundaries, blocking artifacts at object boundaries can be reduced.

It is to be noted that any one or more of the aspects and embodiments described herein may be conveniently implemented using digital electronic circuitry, integrated circuitry, specially designed application specific integrated circuits (ASICs), field programmable gate arrays (FPGAs) computer hardware, firmware, software, and/or combinations thereof, as realized and/or implemented in one or more machines (e.g., one or more computing devices that are utilized as a user computing device for an electronic document, one or more server devices, such as a document server, etc.) programmed according to the teachings of the present specification, as will be apparent to those of ordinary skill in the computer art. These various aspects or features may include implementation in one or more computer programs and/or software that are executable and/or interpretable on a programmable system including at least one programmable processor, which may be special or general purpose, coupled to receive data and instructions from, and to transmit data and instructions to, a storage system, at least one input device, and at least one output device. Appropriate software coding may readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, Programmable Logic Devices (PLDs), and/or any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

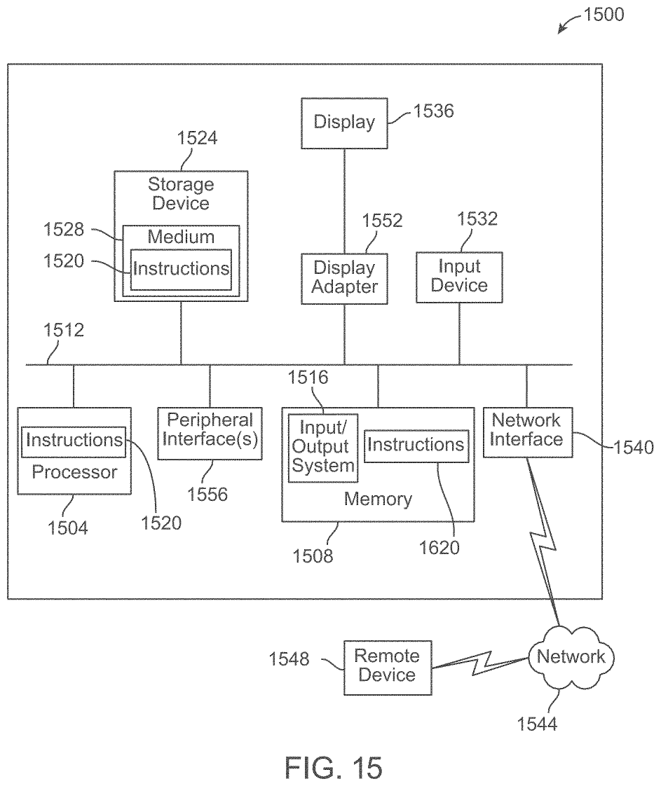

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof. Display adapter 1552 and display device 1536 may be utilized in combination with processor 1504 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments as disclosed herein. Accordingly, this description is meant to be taken only by way of example, and not to otherwise limit the scope of this invention.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A decoder, the decoder comprising circuitry configured to:
receive a bitstream;
partition a current block via an exponential partitioning mode into a first region and a second region;
determine a motion vector associated with a region of the first region or the second region, wherein determining includes constructing a candidate list; and
decode the current block using the determined motion vector.

2. The decoder of claim 1, wherein the exponential partitioning mode further comprises a geometric partitioning mode.

3. The decoder of claim 1, further configured to determine that a merge mode is enabled for the first region.

4. The decoder of claim 1, further configured to reconstruct pixel data of the current block, the first region and the second region being non-rectangular.

5. The decoder of claim 1, wherein the exponential partitioning mode is available for block sizes greater or equal to 8×8 luma samples.

6. The decoder of claim 1, further comprising:
an entropy decoder processor configured to receive the bitstream and decode the bitstream into quantized coefficients;
an inverse quantization and inverse transformation processor configured to process the quantized coefficients including performing an inverse discrete cosine transform;
a deblocking filter;
a frame buffer; and
an intra prediction processor.

7. The decoder of claim 1, wherein the current block forms part of a quadtree plus binary decision tree.

8. The decoder of claim 7, wherein the current block is a non-leaf node of the quadtree plus binary decision tree.

9. The decoder of claim 1, wherein the current block is a coding tree unit;

10. The decoder of claim 1, wherein the current block is a coding unit.

11. A method, the method comprising:
receiving, by a decoder, a bitstream
partitioning, by the decoder, a current block via an exponential partitioning mode into a first region and a second region;
determining, by the decoder, a motion vector associated with a region of the first region or the second region, the determining including constructing a candidate list; and
decoding, by the decoder, the current block using the determined motion vector.

12. The method of claim 11, wherein the exponential partitioning mode further comprises a geometric partitioning mode.

13. The method of claim 11, further comprising determining that a merge mode or advanced motion vector prediction mode is enabled for the first region.

14. The method of claim 11, further comprising reconstructing pixel data of the current block, the first region and the second region being non-rectangular.

15. The method of claim 11, wherein the exponential partitioning mode is available for block sizes greater or equal to 8×8 luma samples.

16. The method of claim 11, wherein the decoder further comprises:
an entropy decoder processor configured to receive the bitstream and decode the bitstream into quantized coefficients;
an inverse quantization and inverse transformation processor configured to process the quantized coefficients including performing an inverse discrete cosine transform;
a deblocking filter;
a frame buffer; and
an intra prediction processor.

17. The method of claim 11, wherein the current block forms part of a quadtree plus binary decision tree.

18. The method of claim 17, wherein the current block is a non-leaf node of the quadtree plus binary decision tree.

19. The method of claim 11, wherein the current block is a coding tree unit

20. The method of claim 11, wherein the current block is a coding unit.
